(19) United States
(12) Patent Application Publication
(10) Pub. No.: US 2017/0334361 A1
(43) Pub. Date: Nov. 23, 2017

(54) 3D MODULAR EXPANDABLE TRAILER HITCH MOUNTING ARRAY SYSTEM

(71) Applicants: Matthew Joel Jones, Sachse, TX (US); Henry Aldon Thomas, Frisco, TX (US)

(72) Inventors: Matthew Joel Jones, Sachse, TX (US); Henry Aldon Thomas, Frisco, TX (US)

(21) Appl. No.: 15/161,517

(22) Filed: May 23, 2016

(51) Int. Cl. B60R 9/06; F16M 11/20; F16M 11/32

(52) U.S. Cl. CPC B60R 9/06; F16M 11/32; F16M 11/2085; F16M 11/2092

(57) ABSTRACT

A modular apparatus to enable users to multiply the number of objects being supported by a single trailer hitch receiver which installs into a trailer hitch receiver, which can be connected to an automobile, or which rests independently on stands positioned underneath the apparatus, forming a three dimensional array of interconnected mounting brackets used to support objects above the ground with a plurality of configurations possible wherein the user can vary the width, length and height of the array by adjusting the modular components within the limits of the modular component.

### CROSS-REFERENCE TO RELATED APPLICATION 35 USC §119(e)

Not applicable

### FIELD OF INVENTION

The present invention relates generally to trailer hitch mounting inserts used to form a self-supporting, interlocking, modular component, variable width, length and height apparatus for suspending or elevating items above the ground.

### BACKGROUND OF INVENTION

The use of trailer hitches on automobiles is very common today. Trailer hitches can be temporarily installed on most vehicles. Some vehicles, such as pick-up trucks, SUVs and off-road vehicles typically have permanently installed trailer hitches. Today, a common trailer hitch consists of a two-piece apparatus comprised of a receiver which is permanently mounted to the vehicle; and, an insert.

One common insert is a ball hitch. Another common insert is a key-vault. Yet another common insert is a flag pole holder. And still yet another is a cargo carrier or a bike rack. This list is not limiting and is offered to illustrate the widely acceptable and common uses of trailer hitches.

To meet the market demand for towing, supporting, extending, and carrying objects by using the trailer hitch, many manufacturers have products in the market to meet demand for durable, easy to use and interchangeable applications. Accordingly, the manufacturers have developed products with dimensions for the standard ball size, standard receiver size and standard tongue size to allow interoperability between trailer hitch receivers and the apparatuses inserted into them.

The present embodiment introduces a new apparatus to enable users to multiply the number of objects being supported by a single trailer hitch receiver connected to a vehicle, or mounted to a suitable supporting structure, or supported by stands. The present embodiment also introduces a new apparatus designed to meet the needs of using a trailer hitch receiver in an array of multiple supporting mounts simultaneously. Furthermore, the present embodiment introduces a modular apparatus system whereby the user can configure the array of multiple supporting mounts to occupy lateral and vertical space directly behind and above the vehicle so as not to extend beyond the dimensions of the vehicle to which the array is attached; to extend completely outside the dimension of the vehicle to which the array is attached; to rise and be suspended above the vehicle to which the array is attached; or, any other configuration to which the user desires.

The present embodiment introduces a simple modular concept wherein each modular component has a receiver mating end, the tongue, of appropriate dimension to fit into the standard trailer hitch receiver; while also having opposing receiver end or ends to accept support inserts. The present embodiment provides flexibility in configuring the array of multiple supporting mounts using two basic modules, an extension module and a “t” module which interconnect. The limitation of the present embodiment is the number of modules available on hand.

The present embodiment provides a new solution for multiple supporting mounts configured in array for use illustrated by an amateur radio operator requiring multiple antennas suspended at various heights above the ground, directly behind, or completely outside the wheel wells of a pick-up truck. The array can also be illustrated by using the array to support a BBQ grill, foot-step, satellite dish, a television monitor and a college flag elevated on a flag pole at a tailgate event in the parking lot of a stadium. And yet another illustration for using the array could be a Community Emergency Response Team mobile command center supporting HAM radio antenna, flood lights, loud speakers, table tops or umbrellas when deployed into a disaster area after an earthquake, flood, hurricane or tornado.

Although there are several apparatuses which may have various functions related to the modular expandable trailer hitch mounting array system, none of these either separately or in combination with each other, teach or anticipate the current invention. Therefore, there remains an unmet need in the field of the apparatus to enable users to multiply the number of objects being supported by a single trailer hitch receiver. The current invention will fulfill this unmet need.

### SUMMARY OF INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present embodiment introduces a modular apparatus comprised of two basic components used to form mounting arrays connected to a standard trailer hitch receiver mounted to a vehicle, post or other suitable structure with additional supplemental attachments being included with which more complex arrays can be assembled.

The preferred material for constructing the basic modular components is square metal tubing. The first modular component, the extension module, is a two-piece extension module constructed using a larger outer and smaller inner element. The larger outer element is formed by cutting a larger outer square tube to length and drilling hole pairs at both ends suitable to accepting a standard trailer hitch pin or threaded bolt used to interlock other smaller, inner elements which are inserted into the larger outer element. The opposite end of the first larger outer element is used as a receiver for accepting other extension modules; receiving custom mounts made to support items such as a pole to mount televisions, satellite receivers and antenna, foot-steps, BBQ grills, fryers or table tops; or, receiving any other commercially available supporting mounts. The opposite end of the larger outer element is also used as a receiver to receive the second inner element; which when extended forms the tongue to insert into the trailer hitch receiver or receiver of other first or second modules.

The second inner element of the first modular component is formed by cutting a smaller inner tube to length and drilling a single pair of holes at the distant end and also drilling a series of hole pairs at the insert end.

The function of the extension module is to separate the supporting mount in spatial distance to the single trailer hitch receiver. The dimensions of the extension module are calculated to provide flexibility in using the modular system to form an array which can be configured completely within the wheel-well of the vehicle to which the array is attached; or, which can be configured to extend wholly outside the wheel well of the vehicle to which the array is attached. The extension module is also specifically dimensioned to minimize the number of modules a user must have on hand to configure the array.

The second modular component, the “t” module, is a two-piece “t” module constructed similarly to the extension module using a larger outer and smaller inner element. The larger outer element is formed by cutting a larger outer tube, of same dimension as the tube used for the extension module, to length and drilling hole pairs at both ends, and on each end of the “t” cross-member described below, suitable to accepting a standard trailer hitch pin used to interlock other smaller, inner elements which are inserted into the larger outer element. One end of the first larger outer element is used as a receiver for accepting other extension modules; receiving customer mounts made to support items such as pole to mount televisions, satellite receivers and antenna, BBQ grills, fryers or table tops; or, receiving commercially available supporting mounts. The opposite end of the larger outer element and both ends of the “t” cross-member is also used as a receiver to receive the second inner element.

Additionally, the “t” cross member is formed out of the first outer element which is modified by cutting a segment from the mid span of the first outer element, rotating that span 90 degrees and welding the rotated segment to the open ends of the first outer element which resulted from cutting the first outer element. Additionally, a plate which can serve as a step and which also provides support to the “t” cross member welds can be attached to the top side of the “t” module positioned across the end of the “t” module.

Finally, additional hole pairs are drilled on the ends of the segment forming the cross member of the “t”. Once the welds are complete, the first outer element will have the form of a cross. Each end of the “t” cross member is used as a receiver for accepting other extension modules; receiving customer mounts made to support items such as pole to mount televisions, satellite receivers and antenna, BBQ grills, fryers or table tops; or, receiving commercially available supporting mounts.

The second inner element of the second modular component, the “t” module, is formed by cutting a smaller inner tube to length and drilling a single hole pair at the distant end and also drilling a series of hole pairs at the insert end. This element, which when extended, forms the tongue to insert into the trailer hitch receiver or receiver of other first or second modules.

For both the first and second module, the small inner elements can be inserted into the open end of the larger outer elements to form the tongue which inserts into the receiver end of the modules or a standard trailer hitch receiver.

Using these two components, a user may form a suitable array of multiple supporting mounts connected to the vehicle at a single trailer hitch receiver. By way of illustration, using a single “t” module, a user can extend the support mount for a flag pole far enough away from the rear of a pick-up truck to allow sufficient clearance to lower the tailgate. Additional array configurations are possible when utilizing elbow or riser adapters connected to the first or second modules. The elbow and riser adapters can be utilized in series with multiple extension or “t” cross member modules.

Alternatively, the user can configure the array so that all supporting mounts extend beyond the outside wheel well base of the vehicle; or, by using elbow and/or riser adapters, position supporting mounts above and inside the perimeter of the bed of a pick-up truck.

Since the modules presented by the present embodiment are used to form the self-supporting array of multiple supporting mounts, originating from a common connection point at the trailer hitch receiver, the vehicle can be moved with the array configured and attached to the vehicle.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic illustrating an array of the first and second modular components using a trailer hitch receiver to suspend the array also illustrating multiple supporting mounts simultaneously;

FIG. 1A is a simplified schematic illustrating an array of the first and second modular components using a trailer hitch receiver to suspend the array also illustrating multiple supporting mounts simultaneously with additional support stands deployed to increase the array stability;

FIG. 2 is a simplified schematic illustrating an array of the first and second modular components with multiple stands illustrated to stabilize a free standing configuration array of the first and second modular components also illustrating multiple supporting mounts simultaneously;

FIG. 3 is a schematic of the second modular component, the “t” module.

FIG. 4 is a schematic of the first modular component, the “extension” module

FIG. 5 is a schematic of the “elbow” adapter.

FIG. 6 is a schematic of the “riser” adapter.

FIG. 7 is a schematic of the “short” support mount.

FIG. 8 is a schematic of the “long” support mount.

FIG. 9 is a schematic of the “tall” support mount.

FIG. 10 is a schematic of the stand.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION

The claimed subject matter is now described with reference to the drawings. In the following description, for purposes of explanation, numerous specific details are set forth in order to provide a thorough understanding of the claimed subject matter. It may be evident; however, that the claimed subject matter may be practiced with or without any combination of these specific details, without departing from the spirit and scope of this invention and the claims.

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with trailer hitch mounting mechanisms. Specifically, the apparatus and method of use of the present embodiment provides rapid and effective means to deploy an array of multiple mounting supports for use during amateur radio filed operations, CERT disaster response situations, while tailgating and other applicable situations discussed above. These and other unique features of the apparatus and method of use are discussed below and illustrated in the accompanying drawings.

The apparatus and method of use will be understood, both as to its structure, configuration and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

Referring now to the drawings wherein like reference characters identify corresponding or similar elements throughout the several views, the apparatus and method of use are illustrated.

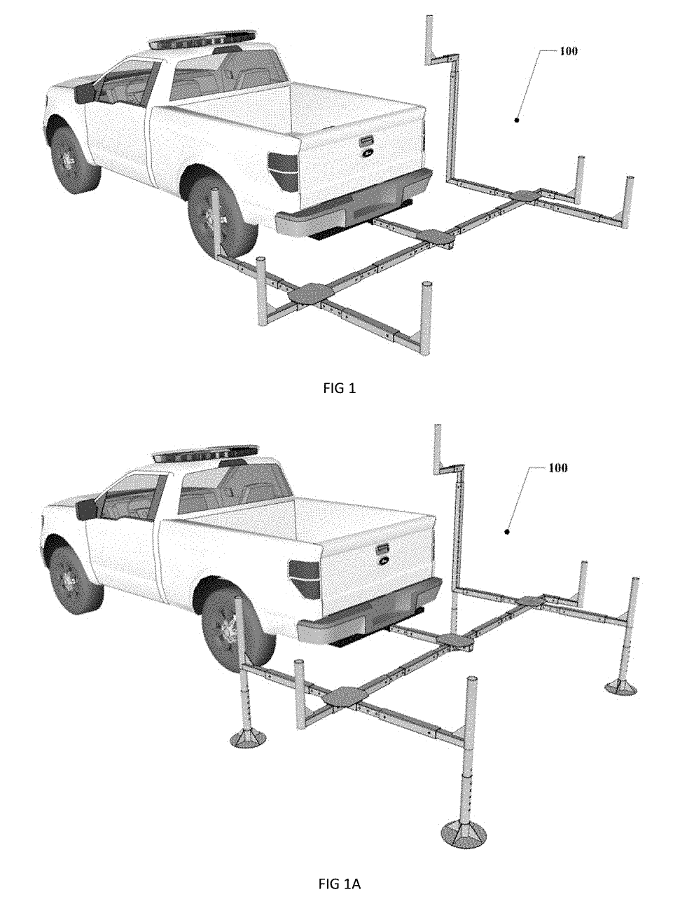

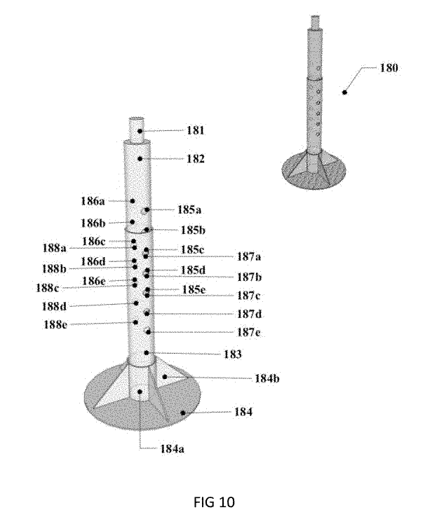

In FIG. 1, the array of modular components 100 with a plurality of supporting mounts is shown as being connected to and being self-supporting by the trailer hitch receiver connected to a pick-up truck. In FIG. 1A, the same array of modular components 100 with a plurality of supporting mounts is shown with additional stability introduced to the array using four stands 180, with the stand 180 FIG. 10 connected under each of four perimeter supporting mounts.

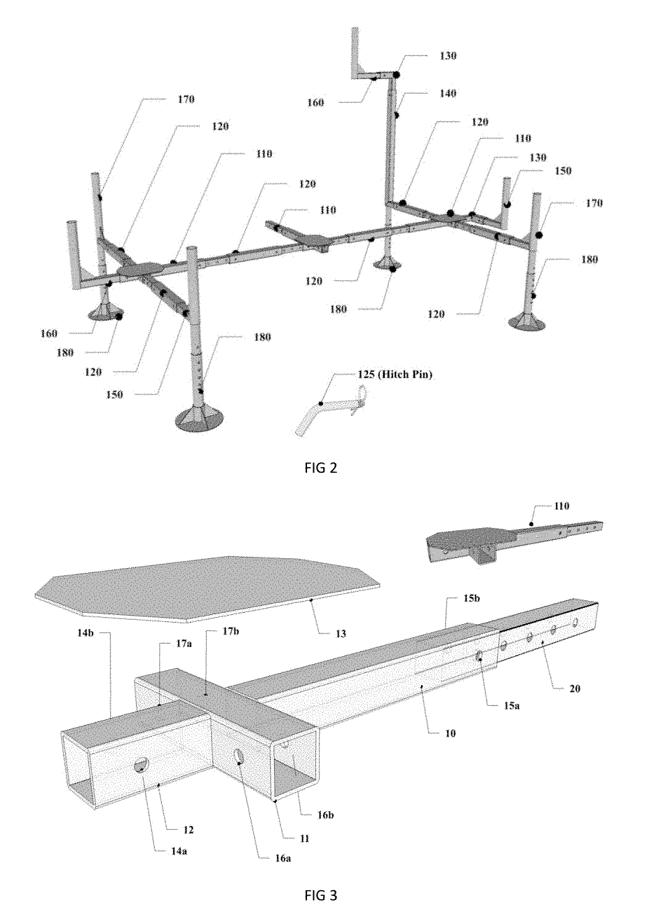

In FIG. 2, the array of modular components 100 with a plurality of supporting mounts 150, 160, and 170 is shown as being free-standing being supported by four stands 180 stabilizing the array.

In FIG. 2, the central point is the base T 110 component, a “t” module. The next component to the right is the extension 120 component, an extension module, connected to the right receiver port of the base T 110 component. The tongue of the extension 120, is inserted into the receiver of the base T 110. The next component to the right is another base T 110 component connected to the prior extension 120 component. The tongue of the base T 110 component is inserted into the receiver port of the extension 120 component. This configuration can be repeated to create an array of components suitable to the user's preference.

Next, the elbow 130 component is inserted into the center port of prior base T 110 component. The function of the elbow 130 is to change direction of the array. The elbow 130 can be inserted to turn the direction of the next component left or right, or if the elbow 130 is rotated 90 degrees, turn the direction vertical. Each elbow 130 component has a tongue which inserts into the prior receiver of an extension 120 component, or a base T component 110 as shown here.

The next component shown is a short 150 support mount connected to the prior elbow 130 component. The short 150 support mount is illustrative of any number of commercially available mounting supports sized to fit a standard trailer hitch receiver.

Returning to the base T component 110 which the elbow 130 is connected to the center port, FIG. 2 shows two extension 120 components, one each connected to each the right and left port of the base T 110 component. For each extension 120 component, the tongue is inserted into the respective right and left receiver port of the base T 110 component.

Looking at the extension 120 component connected to the right receiver port of the base T component, a tall 170 support mount is shown. A stand 180 is positioned underneath the base of the tall 170 support mount. Looking at the extension 120 component connected to the left receiver port of the base T 110 component, a riser 140 component is connected to the extension 120 component by inserting the tongue of the riser 140 into the receiver of the extension 120. A stand 180 is positioned underneath the base of the Riser 140 support mount to provide additional stability when desired. The riser 140 component has a built in elbow to change from the horizontal direction of the extension 120 component to the vertical direction of the riser 140. The user may utilize the riser 140 component as a long extension elbow by rotating the riser 140 90 degrees.

FIG. 2 shows next an elbow 130 component connected to the riser 140 component. The tongue of the elbow 130 component is inserted into the receiver of the riser 140 component. Next, a long 160 support mount is shown as being connected to the elbow 130. The tongue of the long 160 support mount is inserted into the receiver of the elbow 130 component.

Universally, the interconnection of components described above illustrate the present embodiment and versatility of the array of modular components 100 presented herein. The present embodiment shown illustrates how the components 110, 120, 130, 140, 150, 160, 170 and 180 can be sequenced to form the array of modular components 100. Also shown and described above is the inherent flexibility to rotate any component 90 degrees to change direction and elevation.

Returning to the central point, which is the base T 110 component inserted into the trailer hitch receiver connect to the vehicle, a “t” module, the next component to the left is the extension 120 connected to the left receiver port of the base T 110 component. The tongue of the extension 120, an extension module, is inserted into the left receiver of the base T 110. The next component to the left is another base T 110 component connected to the prior extension 120 component. The tongue of the base T 110 component is inserted into the receiver port of the extension 120 component. This configuration can be repeated to create an array of components suitable to the user's preference.

The next component shown is a long 160 support mount connected to the center port of the prior base T 100 component. The long 160 support mount is illustrative of any number of commercially available mounting supports sized to fit a standard trailer hitch receiver.

Returning to the base T component 110, FIG. 2, left branch, two extension 120 components are shown, one each connected to each the right and left port of the base T 110 component. For each extension 120 component, the tongue is inserted into the left and right receiver port of the Base T 110 component, respectively.

Looking at the extension 120 component connected to the left receiver port of the base T component, a short 150 support mount is shown. A stand 180 is positioned underneath the base of the short 150 support mount. Looking at the extension 120 component connected to the right receiver port of the base T 110 component, a tall 170 support mount is connected to the extension 120 component by inserting the tongue of the tall 170 support mount into the receiver of the extension 120. A stand 180 is positioned underneath the base of the tall 170 support mount to provide additional stability when desired.

Such versatility allows the user to configure the array of modular components 100 to occupy space behind the rear of a pick-up truck as shown in FIG. 1 or to be deployed free-standing as shown in FIG. 2. The user may decide to extend the array of modular components to a length sufficient to support all attached mast supports outside the wheel base of the vehicle, inside the wheel-base of the vehicle, or even above the vehicle, as shown in FIG. 1, above and inside the perimeter of the bed of the pick-up truck. In FIG. 1A, the same array of modular components is shown with four additional stand 180 components to illustrate how the user can stabilize the array under extreme uses. Other stabilizing techniques can be employed including, but not limited to using guy ropes, weights, or cross bracing.

In FIG. 2, a standard hitch-pin 125, alternatively a ⅝″ threaded bolt washer and nut, may be utilized to pin the modular components through the receiver and tongue coupling.

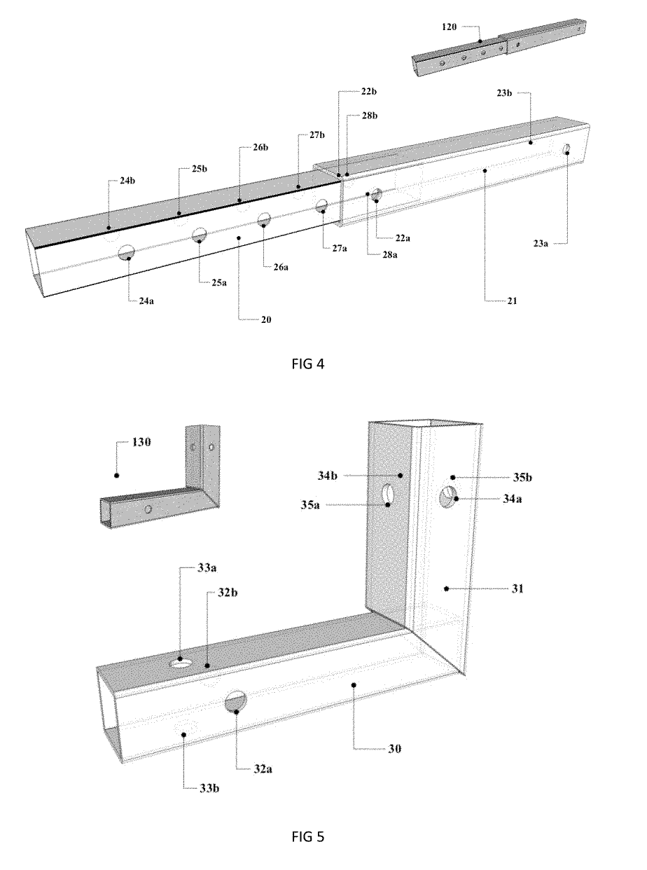

FIG. 3 illustrates the base T 110 component, the “t” module, comprised of the outside base 10, cross member 11, top 12 and plate 13. Hole pair 15a and 15b is shown which is utilized to pin the outside base 10 element receiver with the tongue 20 element inserted. The tongue element 20 is made from the smaller inside square tubing with hole pairs 24-28a and 24-28b FIG. 4 positioned laterally along the span of the tongue 20 element.

FIG. 3 illustrates the cross member 11 element permanently positioned at the top of the outside base 10 element. Hole pairs 16a and 16b, 17a and 17b are positioned at the right and left ends of the cross member 11 element. These hole pairs are utilized to pin other components connected to the cross member 11 element of the base T component.

FIG. 3 also illustrates the top 12 element as being permanently connected to the cross member 11 element. Hole pairs 14a and 14b are utilized to pin other components connected to the top of the base T 110 component.

In FIG. 3, plate 13 element is permanently positioned to the outside base 10 element, both left and right sides of the cross member 11 element and the top 12 element to provide structural strength to the cross member 11 element welds to the outside base 10 element and the top 12 element of the base T 110 component.

The hole pairs 24a-28a and 24b-28b FIG. 4 of the tongue 20 element provide versatility to the base T 110 component FIG. 3 and the extension 120 Component FIG. 4 by allowing the user to adjust the insertion depth of the tongue 20 element into the outside base 10 element of the base T 110 Component FIG. 3 and the outside sleeve 21 element of the extension 120 component FIG. 4. This adjustability allows the base T 110 and extension 120 components to be longer or shorter depending on the dimension and clearances of the array of modular component 100 desired. This adjustable range provides for spatial separation of support mounts; horizontal and vertical RF isolation, EMI isolation and antenna pattern interference mitigation; and balancing of weight supported by the array of modular components 100.

In FIG. 4, the extension 120 component is illustrated. Here, the outside sleeve 21 element is shown. The tongue 20 element is also shown as being inserted into the lower receiver of the outside sleeve 21 element. Hole pair 22a-22b of the outside sleeve 21 element is used in conjunction with hole pairs 24-28a and 24-28b of the tongue 20 element to secure the length of the extension 120 component. Hole pair 23a-23b of the outside sleeve 21 element is used to pin the tongue of other elements or components inserted into the receiver of the extension 120 component.

In FIG. 5, the elbow 130 component is shown. The elbow 130 component is made by fitting smaller square tubing to form the tongue 30 element at a right angle with larger outside tubing to form the receiver 31 element. Hole pairs 34a-34b, 35a-35b are positioned to be utilized to pin other components inserted into the receiver 31 element of the elbow 130 component. Hole pairs 32a-32b, 33a-33b are positioned to be utilized to pin the tongue 30 element to other receiver of components which the elbow 130 component is inserted.

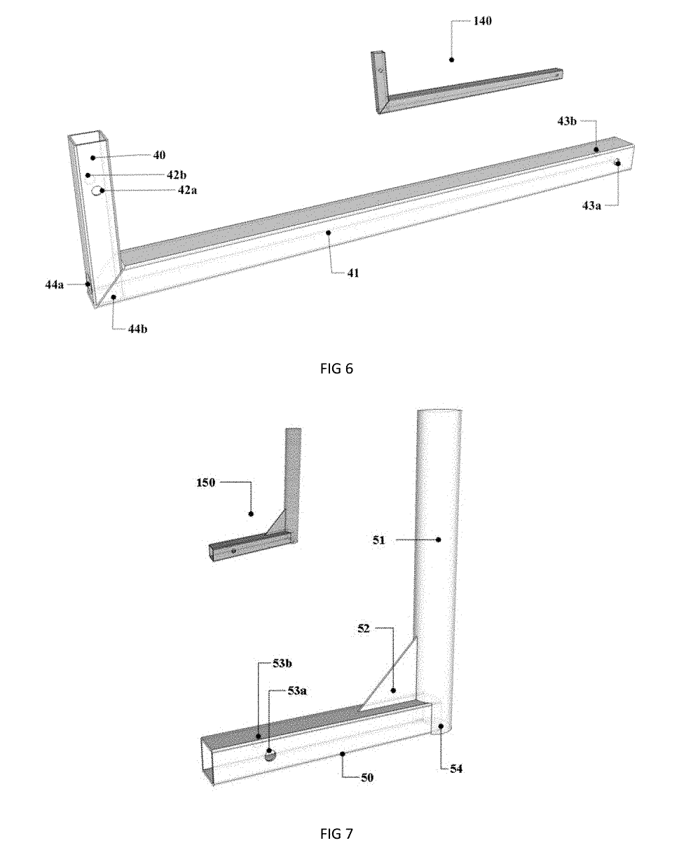

In FIG. 6, the riser 140 component is shown. The riser 140 component is made by fitting smaller square tubing to form the tongue 40 element at a right angle with larger and longer outside tubing to form the receiver 41 element. Hole pair 43a-43b of the receiver 41 element is positioned to be utilized to pin other components inserted into the receiver 41 element of the riser 140 component. Hole pair 42a-42b of the tongue 40 element is positioned to be utilized to pin other receiver of components which the riser 140 component is inserted. Additional hole pairs may be added to increase the versatility providing for the rotation of the riser to meet other configuration requirements. Hole 44a and 44b are provided to allow connection using a Stand 180 FIG. 10 to provide additional stability when desired.

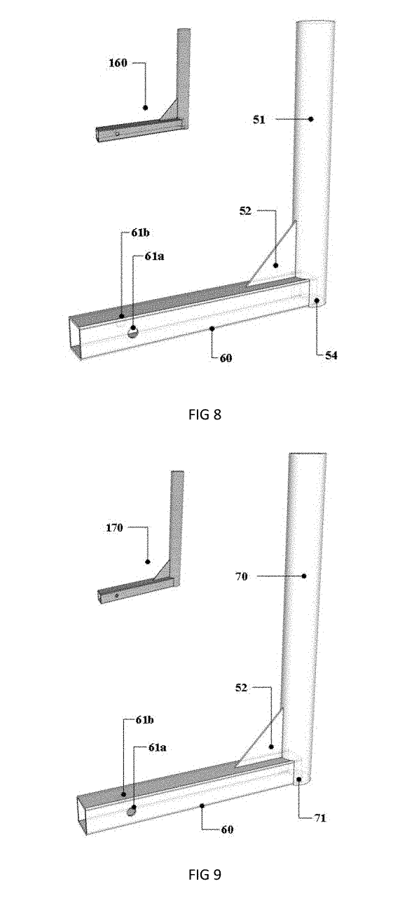

FIG. 7 illustrates the short 150 support mount. This component is made using the smaller square tubing to for the tongue 50 element, which is joined at a right angle with the round receiver 51 element. Hole pair 53a-53b is positioned to pin the tongue 50 element with the other component receivers which the short 150 support mount is inserted. The corner brace 52 element is shown as additional support between the tongue 50 element and the round receiver 51 element. Hole 54 is positioned at the bottom of the round receiver 51 element to facilitate draining and/or to connect the Stand 180 for support as shown in FIG. 2.

As an additional note, FIG. 7 illustrates the short 150 support mount as a fixed 90-degree fixture. The present embodiment does not limit the support mount to a ridged fixture. If desired, the corner brace 52 element can be detachable from the round receiver 51 element which could pivot on hinges attached to the tongue 50 element and the round receiver 51 element.

FIG. 8 illustrates the long 160 support mount. This component is made using longer smaller square tubing to for the tongue 60 element, which is joined at a right angle with the round receiver 51 element. Hole pair 61a-61b is positioned to pin the tongue 60 element with the other component receivers which the long 160 support mount is inserted. The corner brace 52 element is shown as additional support between the tongue 60 element and the round receiver 51 element. Hole 54 is shown as described above.

FIG. 9 illustrates the tall 170 support mount. This component is made using longer smaller square tubing to for the tongue 60 element, which is joined at a right angle with the round receiver 70 element, which is taller. Hole pair 61a-61b is positioned to pin the tongue 60 element with the other component receivers which the tall 170 support mount is inserted. The corner brace 52 element is shown as additional support between the tongue 60 element and the round receiver 70 element. Hole 71 is shown to perform drainage and support functions as described for Hole 54 above.

In FIG. 7-8, and FIG. 9, hole 54 and hole 71 respectively illustrates the location where the stand 180 inserts to stabilize the array of modular components. Additionally, these holes allow the support mounts to drain.

In FIG. 10, the stand 180 is shown. The stand 180 is comprised of a solid round bar 181 element with a shoulder 182 suitable to inserting the shaft of the solid round bar 181 element into hole 54 or 71 of the support stands 150, 160 or 170 or into the hole 44a or 44b of the riser 140. Hole pairs 185a-e and 186a-e are positioned along the lower shaft of the solid round bar 181 element. A stand sleeve 183 element with hole pairs 187a-e and 188a-e is inserted into the collar 184a attached to the stand base 184. The collar 184a is secure to and supported by corner braces 184b. The hole pairs positioned on the solid round bar 181 element and the stand sleeve 183 element are utilized to adjust the height of the Stand 180.

This versatility described above to arrange the assembly sequence of the various modular components allows the user to deploy the array in a wide variety of configurations which illustrates the versatility of the present embodiment.

The present embodiment is not restricted in use or application to round support system similar to what is described herein. Addition supports for televisions, BBQ grills, satellite antennas, flog poles, foot-steps, banner supports and other commercially available or custom made support mounts are feasible and would not diminish the utilize of the embodiment presented herein. Nor is the present embodiment restricted in use or application to trailer hitch receivers affixed to a vehicle. The trailer hitch receiver utilized to support the central base T or central extension components could be affixed to a building structure, post in the ground, trailer, tractor or any other plausible mounting solution.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

We claim,

1. An apparatus and method of use for supporting objects adjustably in three dimensions above the ground from a single trailer hitch receiver comprising interchangeable and interconnectable extension modules with tongue and receiver ends; interchangeable and interconnectable “t” modules with tongue and receiver ends; and, a three-dimensional interlinked array of the interconnectable and interchangeable extension modules and “t” modules.

2. The apparatus and method of use in claim 1 further comprising 90 degree increment rotatable elbows with tongue and receiver ends; 90 degree increment rotatable risers with tongue and receiver ends; 90 degree increment rotatable support mounts; and, stands.

3. The apparatus and method of use in claim 1 further comprising the interchangeable and interconnectable extension and “t” modules with adjustable lengths and/or interlinking of modules in series to control the lateral and vertical position in three dimensions when positioning the support mounts which are attachable to the receiver ends of either the interconnectable and interchangeable extension modules or the “t” modules.

4. The apparatus and method of use in claim 1 which when the three-dimensional interlinked array of the interconnectable and interchangeable extension modules and “t” modules is connected to the single trailer hitch receiver connected to a vehicle supports objects above the ground while the vehicle is stationary or in motion.

5. The apparatus and method of use in claim 1 where the modules are adjustable in length to provide electrical, magnetic and radio frequency separation and isolation among multiple antenna attached to, and elevated above the ground, on poles or push-up masts inserted into support mounts attached to the three-dimensional interlinked array of the interchangeable and interconnectable extension modules and “t” modules.

6. An apparatus and method of use for a supporting multiple objects with vertical and horizontal separation above the ground comprising the interchangeable and interconnectable extension modules and “t” modules with tongue and receiver ends; a self-supporting array of the interchangeable and interconnectable extension modules and “t” modules with tongue and receiver ends; support mounts; and stands.

7. An apparatus and method of use for a supporting multiple objects with vertical and horizontal separation above the ground comprising extension modules with tongue and receiver ends; “t” modules with tongue and receiver ends; a self-supporting array of extension modules; “t” modules; support mounts; and stands.
